(19) United States
(12) Patent Application Publication
(10) Pub. No.: US 2008/0016390 A1
(43) Pub. Date: Jan. 17, 2008

(54) APPARATUS, SYSTEM, AND METHOD FOR CONCURRENT STORAGE POOL MIGRATION AND BACKUP

(76) Inventors: David Maxwell Cannon, Tucson, AZ (US); Howard Newton Martin, Vail, AZ (US); Rosa Tesller Plaza, Tucson, AZ (US)

Correspondence Address: Brian C. Kunzler;Kunzler and Associates, Suite 600, 8 East Broadway, Salt Lake City, UT, 84111, US

(21) Appl. No.: 11/457,395

(22) Filed: Jul. 13, 2006

(51) Int. Cl. G06F 11/00

(52) U.S. Cl. 714/6

(57) ABSTRACT

An apparatus, system, and method are disclosed for concurrent storage pool migration and backup. An association module associates at least one copy pool with a second storage pool. A migration module concurrently migrates at least one data file from a first storage pool to the second storage pool and copies the at least one data file to each copy pool associated with the second copy pool that does not already store an instance of the at least one data file. In one embodiment, the migration module further concurrently migrates each data file that the second storage pool cannot receive to a third storage pool.

### BACKGROUND OF THE INVENTION

1. Field of the Invention

This invention relates to storage pool migration and more particularly relates to concurrent storage pool migration and backup.

2. Description of the Related Art

A data processing system often backs up data from one or more elements of the system to a storage subsystem. For example, the data processing system may include a plurality of clients. Clients may store data on storage devices such as hard disk drives that are co-located with each client. The data processing system may back up the data from the client storage devices to the storage subsystem.

The storage subsystem may include one or more storage devices organized into a plurality of storage pools. A storage pool may be configured as one or more logical volumes comprising portions of one or more magnetic tape drives, one or more hard disk drives, one or more optical storage devices, one or more micromechanical storage devices, or the like. Client data may be backed up by being stored in a storage pool.

The storage pools may be organized as a storage hierarchy. Storage pools that are higher in the storage hierarchy may store data that is more frequently accessed while storage pools that are lower in the storage hierarchy may store data that is less frequently accessed. For example, a first storage pool may employ storage devices that are more readily and rapidly accessible and store data with a higher likelihood of being accessed such as recently backed up data. Second and/or third storage pools may employ less readily accessible and more cost effective storage devices to store data with a lower likelihood of being accessed such as data that was archived weeks earlier.

The storage subsystem may migrate data between storage pools in the storage hierarchy. For example, a client may have backed up data to a first storage pool. The backup operation may have occurred during a regularly scheduled time. The first storage pool may comprise a plurality of hard disk drives. The backed up data may be readily available for restoration to a client. Subsequently, as the backup data ages and is less likely to be restored to a client, the storage subsystem may migrate the backup data from the first storage pool to a second storage pool. The second storage pool may be less frequently accessed and store data at lower cost, reducing the cost of longer-term storage of the backup data.

The storage subsystem may also back up data from the storage pools to archival storage devices, referred to herein as copy pools. Copy pools may be magnetic tape drives that store large amounts of data at low cost. The storage subsystem may copy data files from a storage pool to a copy pool to back up the storage pool.

Unfortunately, the many migrations and copies performed by the storage subsystem may reduce the available bandwidth of the storage subsystem. As a result, the storage subsystem may require more expensive hardware, and/or provide a lower level of service to the clients.

From the foregoing discussion, it should be apparent that a need exists for an apparatus, system, and method that reduce bandwidth requirements for migrating and copying data files. Beneficially, such an apparatus, system, and method would reduce the bandwidth required to perform storage pool migration and backup operations.

### SUMMARY OF THE INVENTION

The present invention has been developed in response to the present state of the art, and in particular, in response to the problems and needs in the art that have not yet been fully solved by currently available concurrent copy methods. Accordingly, the present invention has been developed to provide an apparatus, system, and method for concurrent storage pool migration and backup that overcomes many or all of the above-discussed shortcomings in the art.

The apparatus for concurrent storage pool migration and backup is provided with a plurality of modules configured to functionally execute the steps of associating at least one copy pool with a second storage pool and concurrently migrating at least one data file from a first storage pool to the second storage pool and copying the at least one data file to each copy pool associated with the second storage pool that does not already store an instance of the at least one data file. These modules in the described embodiments include an association module and a migration module.

The association module associates one or more copy pools with a second storage pool. The second storage pool may be organized in a storage hierarchy and may be subordinate to a first storage pool. In one embodiment, the copy pools are configured as magnetic tape drives.

The migration module migrates one or more data files from the first storage pool to the second storage pool. In addition, the migration module concurrently copies each data file to each copy pool associated with the second storage pool that does not already store an instance of the data file.

In one embodiment, the migration module concurrently migrates each data file that the second storage pool cannot contain to a third storage pool. The third storage pool may be organized in the storage hierarchy and may be subordinate to the second storage pool. In a certain embodiment, the third storage pool is not immediately subordinate to the second storage pool. For example, at least one fourth storage pool may be immediately subordinate to the second storage pool and the third storage pool may be immediately subordinate to the fourth storage pool. The apparatus concurrently migrates one or more data files from the first storage pool to the second storage pool and to one or more copy pools, reducing the bandwidth required for migration operations.

A system of the present invention is also presented for concurrent storage pool migration and back up. The system may be embodied in a storage subsystem. In particular, the system, in one embodiment, includes a storage hierarchy comprising a first storage pool, a second storage pool, and at least one first copy pool. The system further includes a storage manager comprising an association module and a migration module. In addition, the system may include a third storage pool.

The first storage pool is configured to store data. In one embodiment, the first storage pool stores backup data from a client. The second storage pool is also configured to store data and is subordinate to the first storage pool in the storage hierarchy. The at least one first copy pool is configured to back up a storage pool. In one embodiment, the third storage pool also stores data and is subordinate to the second storage pool in the storage hierarchy.

The storage manager manages the storage hierarchy. The association module associates the at least one first copy pool with the second storage pool. The migration module concurrently migrates at least one data file from the first storage pool to the second storage pool and copies the at least one data file to each first copy pool associated with the second storage pool that does not already store an instance of the at least one data file. In one embodiment, the migration module migrates each data file that the second storage pool cannot contain to the third storage pool. The system concurrently performs migration and storage pool backup for one or more data files to reduce the bandwidth required for these operations.

A method of the present invention is also presented for concurrent storage pool migration and backup. The method in the disclosed embodiments substantially includes the steps to carry out the functions presented above with respect to the operation of the described apparatus and system. In one embodiment, the method includes associating at least one copy pool with a second storage pool and concurrently migrating at least one data file from a first storage pool to the second storage pool and copying the at least one data file to each copy pool associated with the second storage pool that does not already store an instance of the at least one data file.

An association module associates at least one copy pool with a second storage pool. A migration module concurrently migrates at least one data file from a first storage pool to the second storage pool and copies the at least one data file to each copy pool associated with the second storage pool that does not already store an instance of the at least one data file. In one embodiment, the migration module further concurrently migrates each data file that the second storage pool cannot contain to a third storage pool. The method concurrently migrates one or more data files from the first storage pool to storage pools and performs storage pool backup of the data files to copy pools, increasing the efficiency of the migration operation.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The embodiment of the present invention concurrently migrates one or more data files from a first storage pool to a second storage pool and performs storage pool backup of the data files to one or more copy pools. In addition, the embodiment of the present invention may mitigate the inability of the second storage pool to contain one or more files by concurrently migrating each data file that the second storage pool cannot receive to a third storage pool. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a data processing system in accordance with the present invention;

FIG. 2 is a schematic block diagram illustrating one embodiment of a storage hierarchy of the present invention;

FIG. 3 is a schematic block diagram illustrating one embodiment of a migration apparatus of the present invention;

FIG. 4 is a schematic block diagram illustrating one embodiment of a storage manager of the present invention;

FIG. 5 is a schematic flow chart diagram illustrating one embodiment of a concurrent migration method of the present invention;

FIG. 6 is a schematic block diagram illustrating one embodiment of an example of pre-concurrent migration storage pools of the present invention;

FIG. 7 is a schematic block diagram illustrating one embodiment of an example of post-concurrent migration storage pools of the present invention;

FIG. 8 is a schematic block diagram of one alternate embodiment of an example illustrating pre-concurrent migration storage pools in accordance with the present invention; and

FIG. 9 is a schematic block diagram of one alternate embodiment of an example illustrating post-concurrent migration storage pools in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

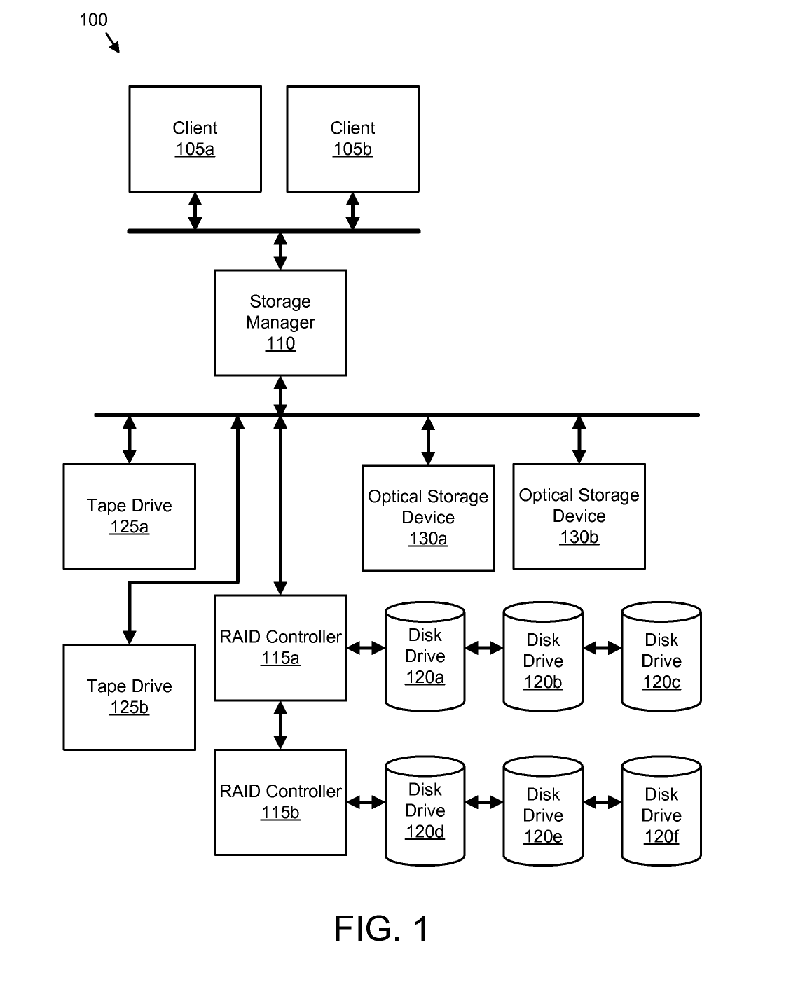

FIG. 1 is a schematic block diagram illustrating one embodiment of a data processing system 100 in accordance with the present invention. The system 100 includes one or more clients 105, a storage manager 110, one or more tape drives 125, one or more redundant array of independent disks (RAID) controllers 115, one or more disk drives 120, and one or more optical storage devices 130. Although for simplicity the system 100 is depicted with two clients 105, one storage manager 110, two tape drives 125, two RAID controllers 115, six disk drives 120, and two optical storage devices 130, any number of clients 105, storage managers 110, tape drives 125, RAID controllers 115, disk drives 120, and optical storage devices 130 may be employed.

The tape drives 125, RAID controllers 115 and disk drives 120, and optical storage devices 130 are collectively referred to herein as storage devices. In addition, the system 100 may include one or more alternate storage devices including micromechanical storage devices, semiconductor storage devices, or the like.

In one embodiment, the storage manager 110 may back up data from the clients 105. In one example, the storage manager 110 may copy one or more data files from a first client 105a to a storage device such as a first disk drive 120a controlled by a first RAID controller 115a. If the first client 105a subsequently requires the data files, the storage manager 110 may copy the data files from the first disk drive 120a to the first client 105a to recover the data files for the first client 105a. In one embodiment, the storage manager 110 copies all data files from a client 105 to a storage device. In an alternate embodiment, the storage manager 110 copies each data file that is modified subsequent to a previous backup to the storage device.

The storage devices may also store data directly for the clients 105. For example, the first RAID controller 115a may store database data for the clients 105 on the disk drives 120. The clients 105 may store and retrieve data through the first RAID controller 115a. The RAID controller 115 may store the database data as redundant data as is well known to those skilled in the art.

The system 100 may organize the storage devices as a plurality of storage pools. A storage pool may include a portion of a storage device such as a first optical storage device 130a, a tape mounted on a first tape drive 125a, and the like. The system 100 may organize the storage pools as a storage hierarchy, as will be described hereafter. In addition, the system 100 may move data between pools to increase or decrease the latency for access to the data and to decrease or increase the cost of storing the data.

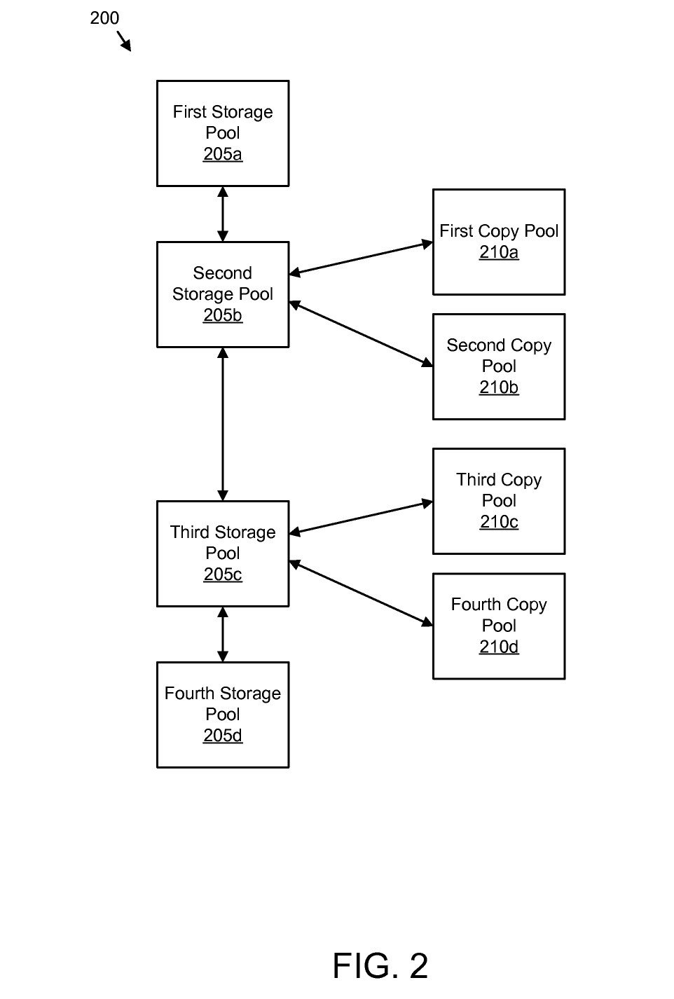

FIG. 2 is a schematic block diagram illustrating one embodiment of a storage hierarchy 200 of the present invention. The hierarchy 200 includes one or more storage pools 205 and one or more copy pools 210. In addition, the hierarchy 200 may be embodied by the data processing system 100 of FIG. 1. The description of the hierarchy 200 refers to elements of FIG. 1, like numbers referring to like elements.

Each storage pool 205 may comprise portions of one or more storage devices. For example, a first storage pool 205a may comprise the first RAID controller 115a and first, second, and third disk drives 120a-c, a second storage pool 205b may comprise a second RAID controller 115b and fourth, fifth, and sixth disk drives 120d-f. In addition, a third storage pool 205c may comprise a first optical storage drive 130a while a fourth storage pool 205d may comprise a second optical storage drive 130b. The copy pools 210 may also comprise portions of one or more storage devices.

The storage manager 110 may migrate data files between storage pools 205 to make data files with a high probability of being accessed more readily available. For example, the storage manager 110 may migrate data files backed up from a client 105 to the first storage pool 205a the previous day to the second storage pool 205b. The storage manager 110 may further back up current data files from the client 105 to the first storage pool 205a. Thus the current backup data files are accessible from the first storage pool 205a while the previous day's backup data files are accessible from the second storage pool 205b. In one embodiment, the per unit cost of storing data files on the second storage pool 205b is less than the per unit cost of storing data files on the first storage pool 205a.

The second and third storage pools 205b, 205c are shown associated with two copy pools 210. However, any storage pool 205 may have any number of copy pools 210. For example, the first and fourth storage pools 205a, 205d may also each have one or more copy pools 210. Additionally, a storage pool 205 may have one or more associated copy pools 210 that are the same as the copy pools 210 associated with another storage pool 205. For example, copy pools 210a and 210c in FIG. 2 may actually be the same copy pool 210. A copy pool 210 may be configured to copy the data files of a storage pool 205 as a backup copy. In one example, a first copy pool 210a may be configured as a tape drive 125. The first copy pool 210a is shown associated with the second storage pool 205b, wherein the first copy pool 210a may receive copies of all data files stored in the second storage pool 205b and store the copies. In a certain embodiment, the copy pools 210 may store data by writing the data to magnetic tape.

The storage manager 110 may migrate data files between storage pools 205 and copy data files to copy pools 210. Because the storage manager 110 may be migrating and copying significant quantities of data, the migration and copy operations may consume significant storage hierarchy bandwidth.

For example, the storage manager 110 may migrate one or more data files from the first storage pool 205a to the second storage pool 205b. Migrating the data files may free storage space for new client backup data files to be stored on the first storage pool 205a. In addition, the storage manager 110 may copy the data files to the first and second copy pools 210a, 210b to back up the second storage pool 205b. The embodiment of the present invention concurrently migrates the data files of the first storage pool 205a to the second storage pool 205b and copies the data files to copy pools 210 as will be explained hereafter.

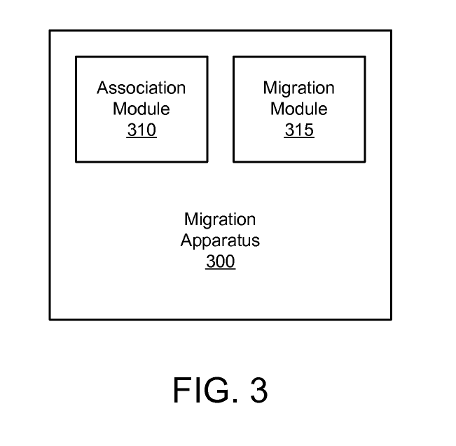

FIG. 3 is a schematic block diagram illustrating one embodiment of a migration apparatus 300 of the present invention. The apparatus 300 includes an association module 310 and a migration module 315. The description of the apparatus 300 refers to elements of FIGS. 1-2, like numbers referring to like elements. The apparatus 300 may be embodied in the storage manager 110.

The association module 310 associates one or more copy pools 210 with the second storage pool 210b. For example, the association module 310 may associate the first and second copy pools 210a, 210b with the second storage pool 210b as shown in FIG. 2.

The migration module 315 migrates one or more data files from the first storage pool 205a to the second storage pool 205b. In addition, the migration module 315 concurrently copies the data files to each copy pool 210 associated with the second storage pool 205b that does not already store an instance of the data files. For example, the migration module 315 may migrate a first and second data file from the first storage pool 205a to the second storage pool 205b and concurrently copy the first data file to the first and second copy pools 210a, 210b. However, if the second copy pool 210b already stores an instance of the second data file, the migration module 315 may only copy the second data file to the first copy pool 210a. An example of migrating data files will be described hereafter.

In one embodiment, the migration module 315 concurrently migrates each data file that the second storage pool 205b cannot contain to a third storage pool 205c. The third storage pool 205c may be immediately subordinate to the second storage pool 205b, wherein the third storage pool 205c is configured to receive data files migrated directly from the second storage pool 205b.

In an alternate embodiment, the third storage pool 205c is not immediately subordinate to the second storage pool 205. For example, the order of storage pools 205 of FIG. 2 may be changed, with the fourth storage pool 205d immediately subordinate to the second storage pool 205b and the third storage pool 205c may be immediately subordinate to the fourth storage pool 205d. The migration module 315 may bypass the fourth storage pool 205d so configured and concurrently migrate each data file that the second storage pool 205b cannot receive to the third storage pool 205c.

The apparatus 300 concurrently migrates one or more data files from the first storage pool 205a to the second storage pool 205b and copies the data files to one or more copy pools 210. By concurrently migrating and copying the data files, the apparatus 300 may reduce the bandwidth required for storage pool migration and backup operations. For example, the storage controller 110 may only perform a single concurrent operation to both migrate a data file to the second storage pool 205b and to copy the data file to the copy pools 210. As a result, the consumption of storage controller 110 processing bandwidth, the consumption of communication channel traffic, and the like, are reduced.

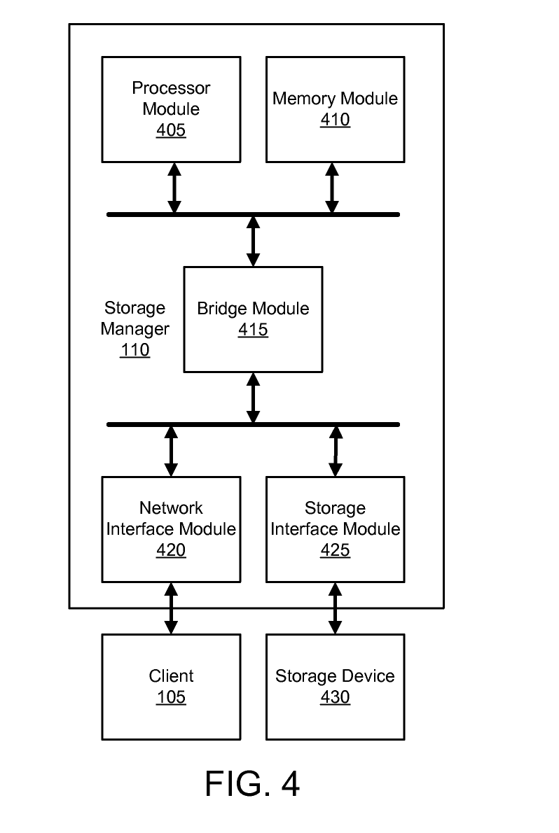

FIG. 4 is a schematic block diagram illustrating one embodiment of a storage manager 110 of the present invention. The storage manager 110 and the client 105 may be the storage manager 110 and client 105 of FIG. 1 while the storage device 430 is representative of the storage devices described in FIG. 1. Although only one storage device 430 is depicted, any number of storage devices 430 may be employed. In addition, the description of the storage manager 110 refers to elements of FIGS. 1-3, like numbers referring to like elements.

The storage manager 110 includes a processor module 405, a memory module 410, a bridge module 415, a network interface module 420, and a storage interface module 425. In addition, the storage manager 110 is shown in communication with the client 105 and the storage device 430.

The processor module 405, memory module 410, bridge module 415, network interface module 420, and storage interface module 425 may be fabricated of semiconductor gates on one or more semiconductor substrates. Each semiconductor substrate may be packaged in one or more semiconductor devices mounted on circuit cards. Connections between the processor module 405, the memory module 410, the bridge module 415, the network interface module 420, and the storage interface module 425 may be through semiconductor metal layers, substrate to substrate wiring, circuit card traces, and/or wires connecting the semiconductor devices.

The memory module 410 stores software instructions and data. The processor module 405 executes the software instructions and manipulates the data as is well know to those skilled in the art. The processor module 405 communicates with the network interface module 420 and the storage interface module 425 through the bridge module 415. The network interface module 420 may communicate with the client 105 through a communications channel such as an Ethernet channel, a token ring channel, or the like. The storage interface module 425 may communicate with the storage device 430 thorough a storage channel such as a Fibre channel communications channel, a small computer system interface (SCSI) channel, an Ethernet channel, or the like.

In one embodiment, the memory module 410 stores and the processor module 405 executes one or more software processes comprising the association module 310 and migration module 315. The memory module 410 may maintain a data table that associates each storage pool 205 with one or more copy pools 210. In one embodiment, the data table records whether the association is a primary association or a temporary association as will be described hereafter.

The association module 310 may associate a copy pool 210 with a storage pool 205 by writing data indicative of the association to the data table. In addition, the migration module 315 may migrate the data files to a storage pool 205 and a copy pool 210 by issuing commands through the storage interface module 425 to read data, communicate the data over one or more communications channels, and to write the data.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

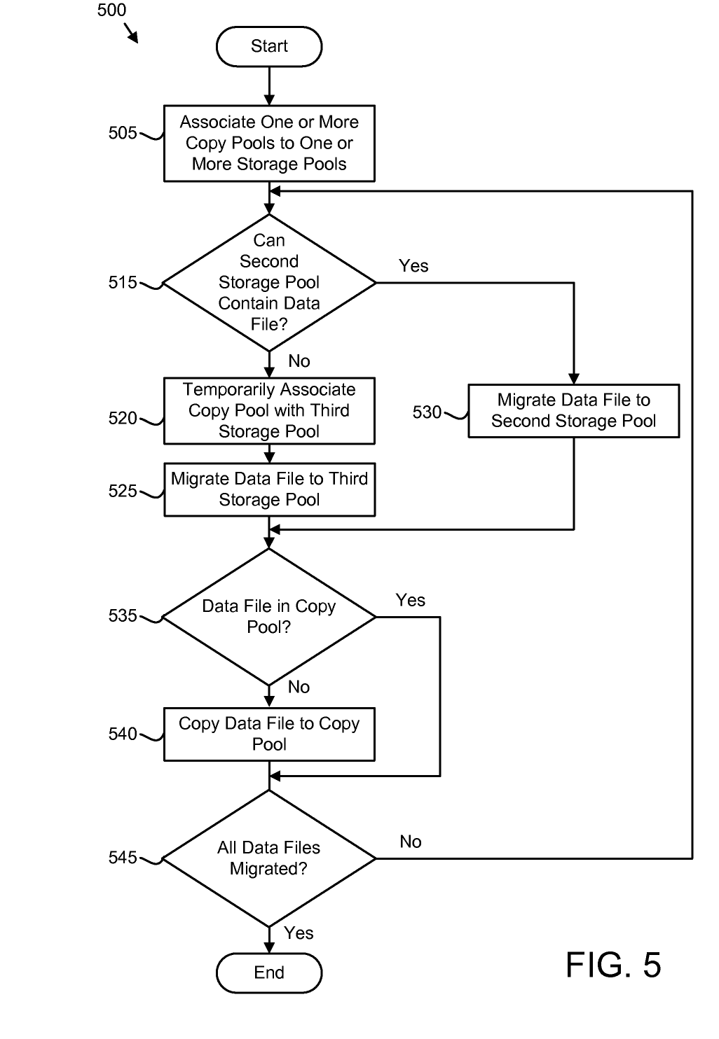

FIG. 5 is a schematic flow chart diagram illustrating one embodiment of a concurrent migration method 500 of the present invention. The method 500 substantially includes the steps to carry out the functions presented above with respect to the operation of the described apparatus 300, 400 and system 100, 200 of FIGS. 1-4. In addition, the description of the method 500 refers to elements of FIGS. 1-4, like numbers referring to like elements.

In one embodiment, the association module 310 associates 505 one or more copy pools 210 to one or more storage pools 205. For example, the association module 310 may associate the first copy pool 210a to the second storage pool 205b. The association may be a primary association wherein the copy pool 210a is regularly associated with the second storage pool 205b.

In one embodiment, the migration module 315 determines 515 if the second storage pool 205b can contain one or more data files being migrated from the first storage pool 205a. For simplicity, the method 500 will be described for migrating one data file. However, a plurality of data files may be migrated together. If the migration module 315 determines 515 that the second storage pool 205b can contain the data file, the migration module 315 migrates 530 the data file to the second storage pool 205b. The first copy pool 210a may remain associated with the second storage pool 205b and the migration module 315 proceeds to determine 535 if the data file resides in the copy pool 210.

If the migration module 315 determines 515 that the second storage pool 205b cannot contain the data file, the association module 310 associates 520 the copy pool 210 with the third storage pool 205c. The association module 310 may associate 520 the copy pool 210 with the third storage pool 205c as a temporary association, wherein the copy pool 210 is associated with the third storage pool 205c for a specified period such as the duration of the migration method 500, the migration of a data file, or the like.

The migration module 315 migrates 525 the data file that cannot be contained by the second storage pool 205b to the third storage pool 205c as is well known to those of skill in the art. Although the migration module 315 migrates 525 the data file to the third storage pool 205c, the migration module 315 may not copy the data file to copy pools 210 that are primarily associated with the third storage pool 205c.

For example, the third and fourth copy pool 210c, 210d may be primarily associated with the third storage pool 205c as shown in FIG. 2. The third and fourth copy pools 210c, 210d are configured to receive copies of data files during migrations of the data files to the third storage pool 205c. However, the migration module 315 will not concurrently migrate data files originally destined to the second storage pool 205b and that instead are migrated 525 to the third storage pool 205c to the third and/or fourth copy pools 210c, 210d.

The migration module 315 determines 535 if the data file resides in the copy pool 210. If the migration module 315 determines 535 the data file resides in the copy pool 210, the migration module 315 determines 545 if all data files are migrated. If the migration module 315 determines 535 that the data file does not already reside in the copy pool 210, the migration module 315 concurrently copies 540 the data file to the copy pool 210 associated with the second storage pool 205b. For example, if the first copy pool 210a does not store the data file, the migration module 315 copies 540 the data file to the first copy pool 210a.

Although the steps of migrating 530 the data file to the second storage pool 205b and copying 540 the data file to the copy pool 210 are shown as distinct steps, migrating 530 and copying 540 the data file occur concurrently. In one embodiment, the storage manager 110 does one write to a communications channel to both migrate 530 and copy 540 the data file. Similarly, the steps of migrating 525 the data file to the third storage pool 205c and copying 540 the data file to the copy pool 210 also occur concurrently.

The migration module 315 determines 545 if all data files are migrated. If all data files are not migrated, the migration module 315 loops to determine 515 if the second storage pool 205b can contain the next migrated data file from the first storage pool 205a. If the migration module 315 determines 545 that all data files are migrated, the method 500 terminates.

The method 500 concurrently migrates and backs up one or more data files. In addition, the method 500 mitigates the inability of the second storage pool 205b to receive the data files during the concurrent migration by associating the copy pool 210 with the third storage pool 205c and concurrently migrating the data files to the third storage pool 205c and the copy pool 210. By concurrently performing migration and storage pool backup of the data files, the method 500 may reduce the bandwidth requirements for the hierarchical system 200.

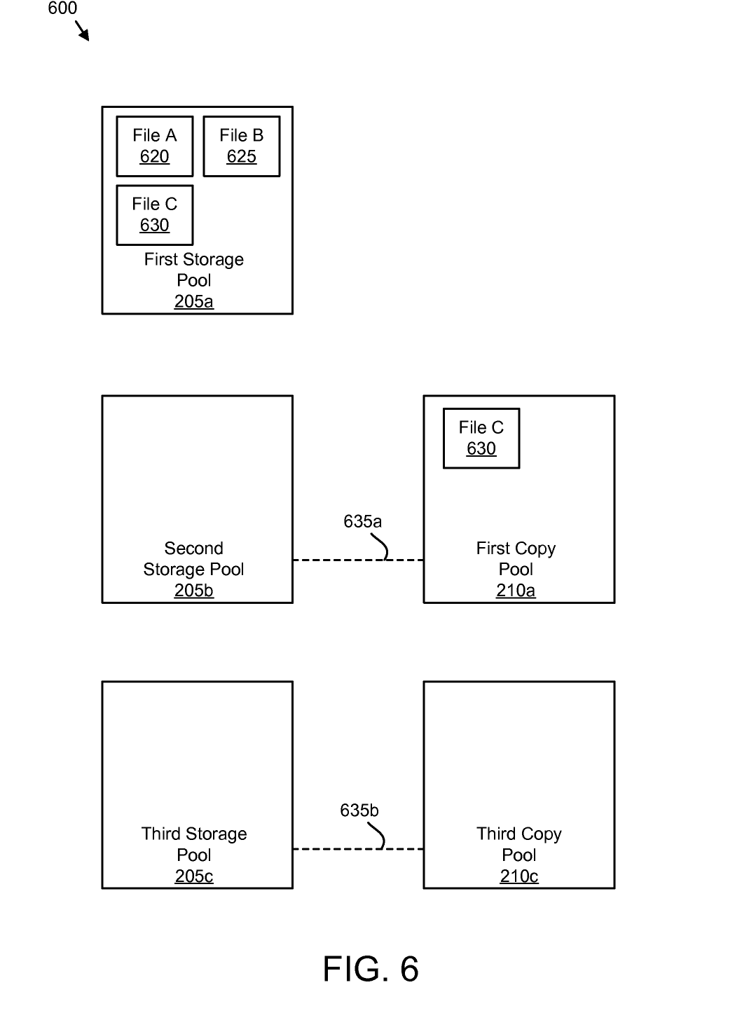

FIG. 6 is a schematic block diagram illustrating one embodiment of pre-concurrent migration storage pools 600 of the present invention. The pools 600 illustrate an example of the method 500 of FIG. 5. The description of the pools 600 refers to elements of FIGS. 1-5, like numbers referring to like elements.

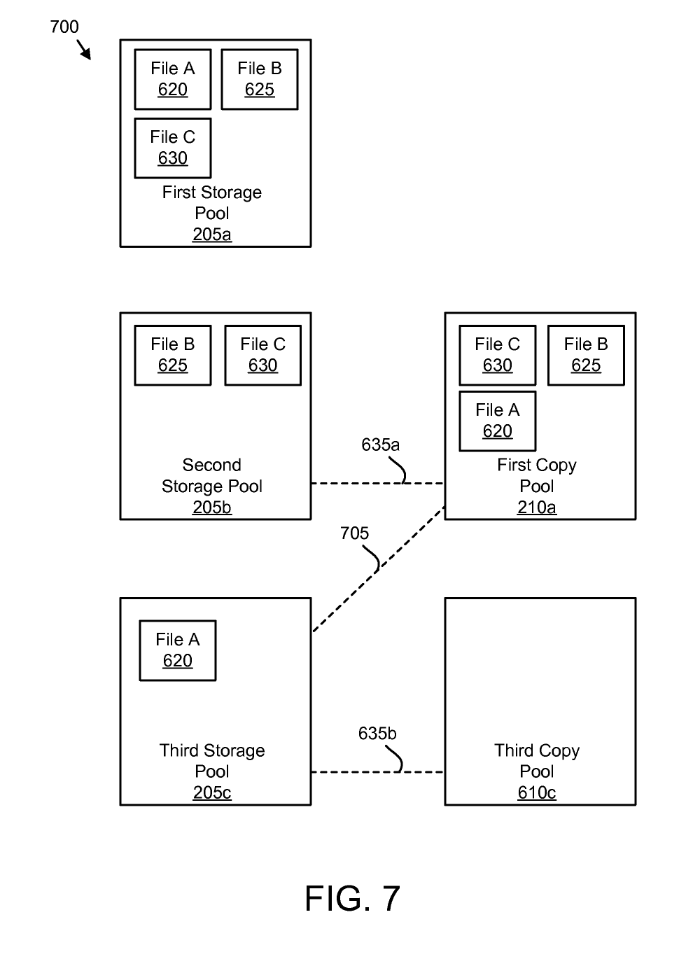

As shown, the first storage pool 205a stores one or more data files, File A 620, File B 625, and File C 630. Although for simplicity the example migrates three data files 620, 625, 630, any number of data files may be migrated. The association module 310 associates 505 the second storage pool 205b with the first copy pool 210a and associates 505 the third storage pool 205c with the third copy pool 210c. The associations are shown as primary associations 635. The files 620, 625, and 630 are configured to be concurrently migrated to the second storage pool 205b and the first copy pool 210a as will be described in FIG. 7.

FIG. 7 is a schematic block diagram illustrating one embodiment of post-concurrent migration storage pools 700 of the present invention. The pools 700 continue the example of FIG. 6. In addition, the description of the pools 700 refers to elements of FIGS. 1-6, like numbers referring to like elements.

The migration module 315 may determine 515 that the second storage pool 205b can contain File B 625 and File C 630. In addition, the migration module 315 may migrate 530 File B 625 and File C 630 to the second storage pool 205b. The migration module 315 may also determine 535 that File B 625 does not reside in the first copy pool 210a and copies 540 File B 625 to the first copy pool 210a. In addition, the migration module 315 determines 535 that File C 630 resides in the first copy pool 210a and does not copy File C 630 to the first copy pool 210a.

However, the migration module 315 may further determine 515 that the second storage pool 205b cannot contain File A 620. The association module 310 associates 520 the first copy pool 210a with the third storage pool 205c. The association of the first copy pool 210a with the second storage pool 205b may be a temporary association 705.

The migration module 315 migrates 525 File A 620 to the third storage pool 205c. In addition, the migration module 315 determines 535 that File A 620 does not reside in the first copy pool 210a and concurrently copies 540 File A to the first copy pool 210a.

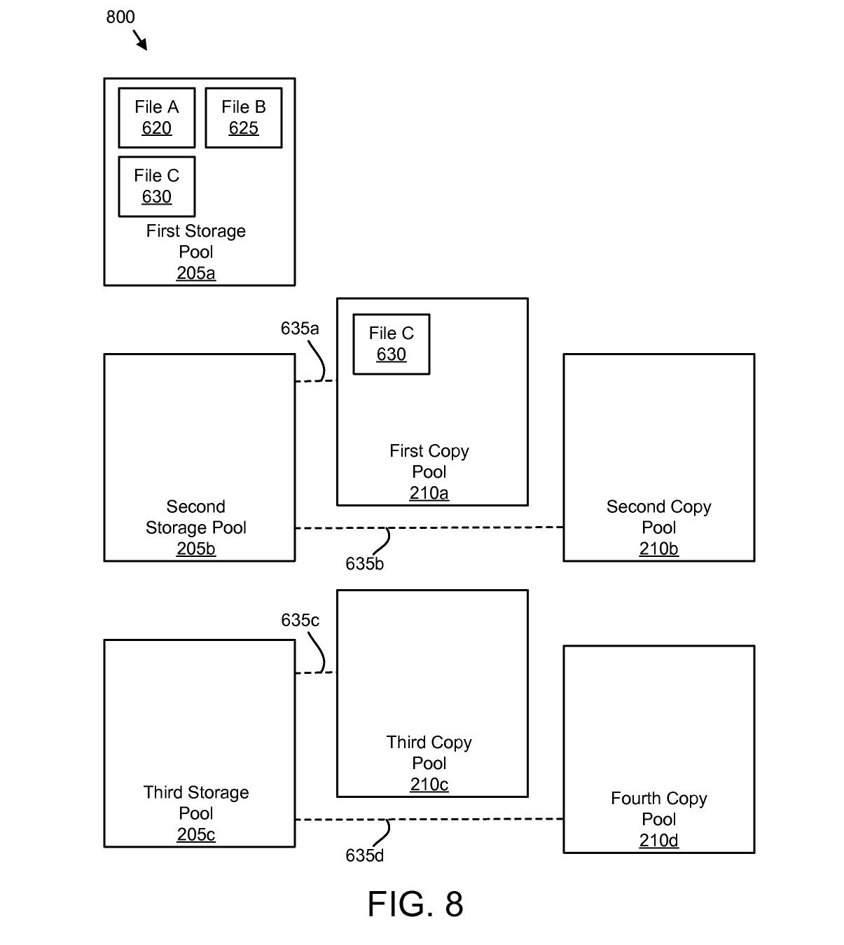

FIG. 8 is a schematic block diagram illustrating one alternate embodiment of pre-concurrent migration storage pools 800 of the present invention. The pools 800 illustrate an alternate example of the method 500 of FIG. 5. The description of the pools 800 refers to elements of FIGS. 1-7, like numbers referring to like elements.

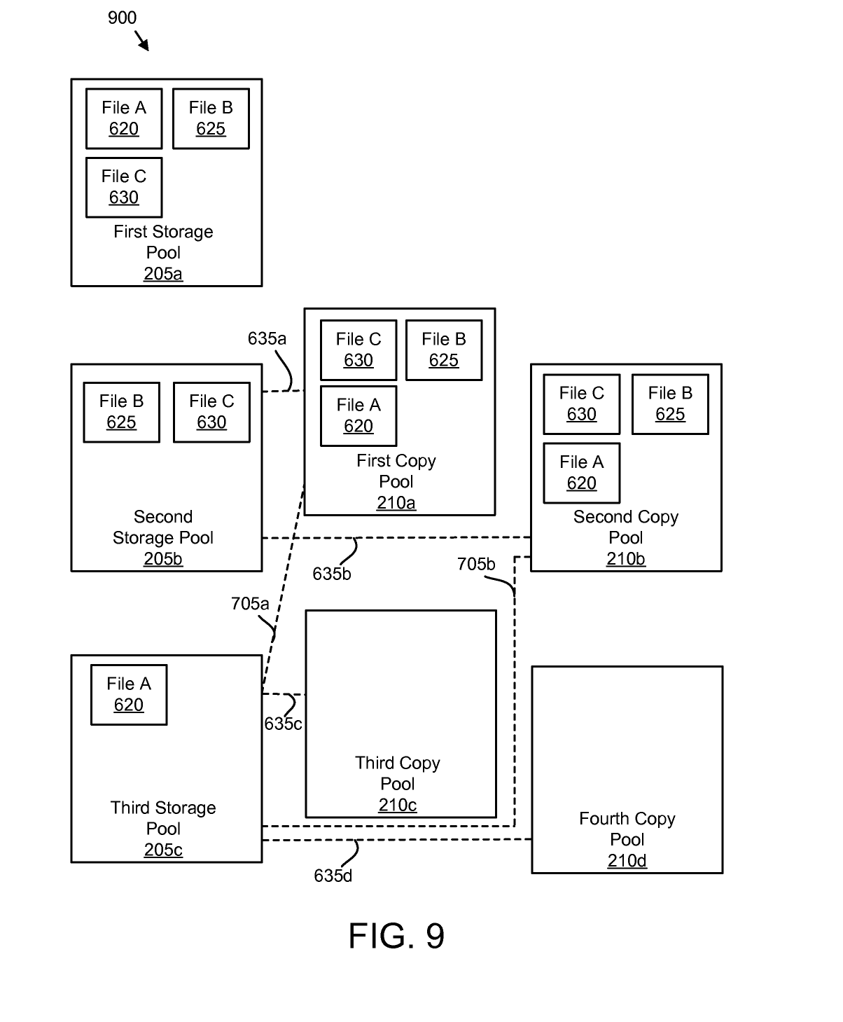

As shown in FIG. 6, the first storage pool 205a stores one or more data files, File A 620, File B 625, and File C 630. The association module 310 associates 505 the second storage pool 205b with the first copy pool 210a and the second copy pool 210b. The associations are primary associations 635. The association module 310 also associates 505 the third storage pool 205c with the third copy pool 210c and the fourth copy pool 210d. The associations of the third storage pool 205c to the third and fourth copy pools 210c, 210d are primary associations 635. The Files 620, 625, and 630 are configured to be concurrently migrated to the second storage pool 205b and the first and second copy pools 210a, 210b as will be described in FIG. 9.

FIG. 9 is a schematic block diagram illustrating one alternate embodiment of post-concurrent migration storage pools 900 of the present invention. The pools 900 continue the example of FIG. 8. In addition, the description of the pools 900 refers to elements of FIGS. 1-8, like numbers referring to like elements.

The migration module 315 determines 515 that the second storage pool 205b can contain File B 625 and File C 630. In addition, the migration module 315 migrates 530 File B 625 and File C 630 to the second storage pool 205b. The migration module 315 also determines 535 that the first and second copy pools 210a, 210b do not store File B 625 and copies 540 File B 625 to the first and second copy pools 210a, 210b. In addition, the migration module 315 determines 535 that File C 630 resides in the first copy pool 210a and only copies 540 File C 630 to the second copy pool 210b.

However, the migration module 315 further determines 515 that the second storage pool 205a cannot contain File A 620. The association module 310 associates 520 the first and second copy pools 210a, 210b with the third storage pool 205c. The association of the first and second copy pools 210a, 210b with the third storage pool 205c may be a temporary association 705.

The migration module 315 migrates 525 File A 620 to the third storage pool 205c. In addition, the migration module 315 determines 535 that File A 620 does not reside in the first and second copy pools 210a, 210b and copies 540 File A 620 to the first and second copy pools 210a, 210b.

The embodiment of the present invention concurrently migrates one or more data files from the first storage pool 205a to the second storage pool 205 and copies the data files to one or more copy pools 210. By concurrently migrating the data files to the second storage pool 205 and copying to the copy pools 210, the present invention may reduce the bandwidth requirements for storage pool migration and backup operations within a hierarchical system 200. In addition, the present invention may mitigate the inability of the second storage pool 205b to contain at least one data file by migrating 525 each data file that the second storage pool 205b cannot contain to a third storage pool 205c, and by concurrently copying 540 the data files to any copy pools 210 associated with the second storage pool 205b. By mitigating the inability of the second storage pool 205b to contain data files, the embodiment of the present invention may reduce the time required for concurrent migration to storage pools 205 and storage pool backup to copy pools 210. This efficiency occurs because the same copy pool resources are used whether the file is actually migrated to the second or third storage pool.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for concurrent storage pool migration and backup, the apparatus comprising:
an association module configured to associate at least one first copy pool with a second storage pool; and
a migration module configured to concurrently migrate at least one data file from a first storage pool to the second storage pool and copy the at least one data file to each first copy pool that does not already store an instance of the at least one data file.

2. The apparatus of claim 1, the migration module further configured to concurrently migrate each data file that the second storage pool cannot contain to a third storage pool.

3. The apparatus of claim 2, wherein the association module is further configured to associate the at least one first copy pool with the third storage pool if the second storage pool cannot receive at least one data file.

4. The apparatus of claim 2, wherein the third storage pool is subordinate to the second storage pool in a storage hierarchy.

5. The apparatus of claim 2, wherein the migration module is further configured to not copy the data files to at least one second copy pool associated with the third storage pool.

6. A computer program product comprising a computer useable medium having a computer readable program, wherein the computer readable program when executed on a computer causes the computer to:
associate at least one first copy pool with a second storage pool; and
concurrently migrate at least one data file from a first storage pool to the second storage pool and copy the at least one data file to each first copy pool that does not already store an instance of the at least one data file.

7. The computer program product of claim 6, wherein the computer readable code is further configured to cause the computer to concurrently migrate each data file that the second storage pool cannot contain to a third storage pool.

8. The computer program product of claim 7, wherein the computer readable code is further configured to cause the computer to associate the at least one first copy pool with the third storage pool if the second storage pool cannot receive at least one data file.

9. The computer program product of claim 7, wherein the third storage pool is subordinate to the second storage pool in a storage hierarchy.

10. The computer program product of claim 7, wherein the computer readable code is further configured to cause the computer to not copy the data files to at least one second copy pool associated with the third storage pool.

11. A method for concurrent storage pool migration and backup, the method comprising:
associating at least one first copy pool with a second storage pool; and
concurrently migrating at least one data file from a first storage pool to the second storage pool and copying the at least one data file to each first copy pool that does not already store an instance of the at least one data file.

12. The method of claim 11, the method further comprising concurrently migrating each data file that the second storage pool cannot contain to a third storage pool.

13. The method of claim 12, further comprising associating the at least one first copy pool with the third storage pool if the second storage pool cannot receive at least one data file.

14. The method of claim 12, wherein the third storage pool is subordinate to the second storage pool in a storage hierarchy.

15. The method of claim 12, further comprising not copying the data files to at least one second copy pool associated with the third storage pool.

16. A system for concurrent storage pool migration and backup, the system comprising:
a storage hierarchy comprising
a first storage pool configured to store data;
a second storage pool configured to store data and that is subordinate to the first storage pool in the storage hierarchy;
at least one first copy pool;
a storage manager configured to manage the storage hierarchy and comprising
an association module configured to associate the at least one first copy pool with the second storage pool; and
a migration module configured to concurrently migrate at least one data file from the first storage pool to the second storage pool and copy the at least one data file to each first copy pool that does not already store an instance of the at least one data file.

17. The system of claim 16, the migration module further configured to concurrently migrate each data file that the second storage pool cannot contain to a third storage pool.

18. The system of claim 17, wherein the association module is further configured to associate the at least one first copy pool with the third storage pool if the second storage pool cannot receive at least one data file.

19. The system of claim 17, wherein the third storage pool is subordinate to at least one fourth storage pool in a storage hierarchy and the at least one fourth storage pool is subordinate to the second storage pool.

20. The system of claim 17, wherein the migration module is further configured to not copy the data files to at least one second copy pool associated with the third storage pool.
